(19) United States
(12) Patent Application Publication
(10) Pub. No.: US 2003/0067448 A1
(43) Pub. Date: Apr. 10, 2003

(54) Touch panel

(75) Inventor: Ji-ryun Park, Busan Metropolitan City (KR)

Correspondence Address: STAAS & HALSEY LLP, 700 11TH STREET, NW, SUITE 500, WASHINGTON, DC, 20001, US

(73) Assignee: SAMSUNG SDI CO., LTD., Suwon-city (KR)

(21) Appl. No.: 10/132,718

(22) Filed: Apr. 26, 2002

(30) Foreign Application Priority Data
Oct. 10, 2001 (KR) 2001-62375

(51) Int. Cl. G09G 5/00

(52) U.S. Cl. 345/173

(57) ABSTRACT

A touch panel including an upper substrate on which upper electrodes are formed; a lower substrate on which lower electrodes are formed to intersect the upper electrodes cross, the lower substrate being disposed to face the upper substrate; and a piezoelectric element disposed between the upper substrate and the lower substrate to detect an input position. Accordingly, an input position on the touch panel can be detected without a power supply unit.

### CROSS-REFERENCE TO RELATED APPLICATIONS

This application claims the benefit of Korean Patent Application No. 2001-62375 filed on Oct. 10, 2001, in the Korean Industrial Property Office, the disclosure of which is incorporated herein by reference.

### BACKGROUND OF THE INVENTION

1. Field of the Invention

The present invention relates to a touch panel, and more particularly, to a touch panel which can detect an input position without a power supply unit.

2. Description of the Related Art

Generally, touch panels are used as input devices of, for example, computers. In a touch panel, if a user presses the surface thereof at a certain position, information corresponding to the pressed position is input. For example, a touch panel is installed on the surface of a monitor of an automatic teller machine (ATM) in a bank. A user can input information by pressing a predetermined position on the touch panel according to a message displayed on the monitor, and the ATM performs a predetermined operation in response to the input information.

There are various types of touch panels such as analog resistive types, digital resistive types, saw types, and infrared types.

FIG. 1 is a diagram of a conventional touch panel. Referring to FIG. 1, a touch panel 10 is an analog resistive type touch panel and includes an upper substrate 11 and a lower substrate 12 disposed to face the upper substrate 11.

Generally, the upper substrate 11 is formed of a film material, and the lower substrate 12 is formed of a glass material. The bottom of the upper substrate 11 is coated with a transparent conductive layer such as an indium tin oxide (ITO) layer. A plurality of upper electrodes 13 are disposed on the bottom of the upper substrate 11 as strips along two opposite ends of the upper substrate 11. A dot spacer 17 is disposed between the upper substrate 11 and the lower substrate 12 so that the upper substrate 11 can be appropriately separated from the lower substrate 12.

The top of the lower substrate 12 is selectively coated with a patterned, transparent conductive layer. A plurality of lower electrodes 14 are disposed on the patterned, transparent conductive layer along both opposite edges to be perpendicular to the upper electrodes 13.

An extension line 15 is withdrawn from one end of each of the lower electrodes 14. In addition, a wire 16, electrically connected to the upper electrodes 13, is disposed on the lower substrate 12. A flexible printed cable 18 is electrically connected to the extension lines 15 and the wire 16 at the center of one edge of the lower substrate 12 .

In such a touch panel 10, a power supply unit (not shown) applies a voltage, to detect an input position, to the upper and lower electrodes 13 and 14. Then, an equipotential is induced in the transparent conductive layer formed on the upper substrate 11 and on the lower substrate 12 through the upper and lower electrodes 13 and 14, respectively. In this state, if a user presses the upper substrate 11 with a predetermined device such as a pen or a finger, the transparent conductive layer formed on the upper substrate 11 contacts the transparent conductive layer formed on the lower substrate 12 so that the transparent conductive layers are electrically connected. Then, a resistance changes at the contact position, and a circuit unit to detect an input position reads a voltage change in response to the change of the resistance and detects an input position based on the changed voltage. A touch panel detecting an input position using the above method is disclosed in Korean Patent No. 2001-51590. Such a touch panel requires a power supply unit to induce an equipotential in the transparent conductive layers formed on respective upper and lower substrates.

### SUMMARY OF THE INVENTION

Accordingly, it is an object of the present invention to provide a touch panel in which upper electrodes are formed in a striped pattern on an upper substrate, lower electrodes are formed in a striped pattern on a lower substrate so that the lower and upper electrodes perpendicularly cross, and a piezoelectric element is installed between the upper electrodes and the lower electrodes, so that an input position can be detected without a power supply unit.

Additional objects and advantages of the invention will be set forth in part in the description which follows and, in part, will be obvious from the description, or may be learned by practice of the invention.

The foregoing and other objects of the present invention are achieved by providing a touch panel including an upper substrate on which upper electrodes are formed; a lower substrate on which lower electrodes are formed to intersect the upper electrodes cross, the lower substrate being disposed to face the upper substrate; and a piezoelectric element disposed between the upper substrate and the lower substrate to detect an input position.

The piezoelectric element is disposed at each of intersections between the upper electrodes and the lower electrodes. In addition, the piezoelectric element has a plate shape. Moreover, the piezoelectric element is disposed at a position where the upper substrate overlaps with the lower substrate.

Since a touch panel according to the present invention uses a piezoelectric element to detect an input position, a power supply unit conventionally used to apply a voltage to detect an input position can be omitted. Accordingly, the structure of a touch panel can be simplified.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is an exploded perspective view of a conventional touch panel;

FIG. 2 is a perspective view of a touch panel according to an embodiment of the present invention;

FIG. 3 is a sectional view of the touch panel of FIG. 2, taken along the line III-III of FIG. 2;

FIG. 4 is a sectional view of the touch panel of FIG. 2, taken along the line IV-IV of FIG. 2;

FIG. 5 is a partially cut-away perspective view of the touch panel of FIG. 2; and

FIG. 6 is a partially cut-away perspective view of a touch panel according to another embodiment of the present invention.

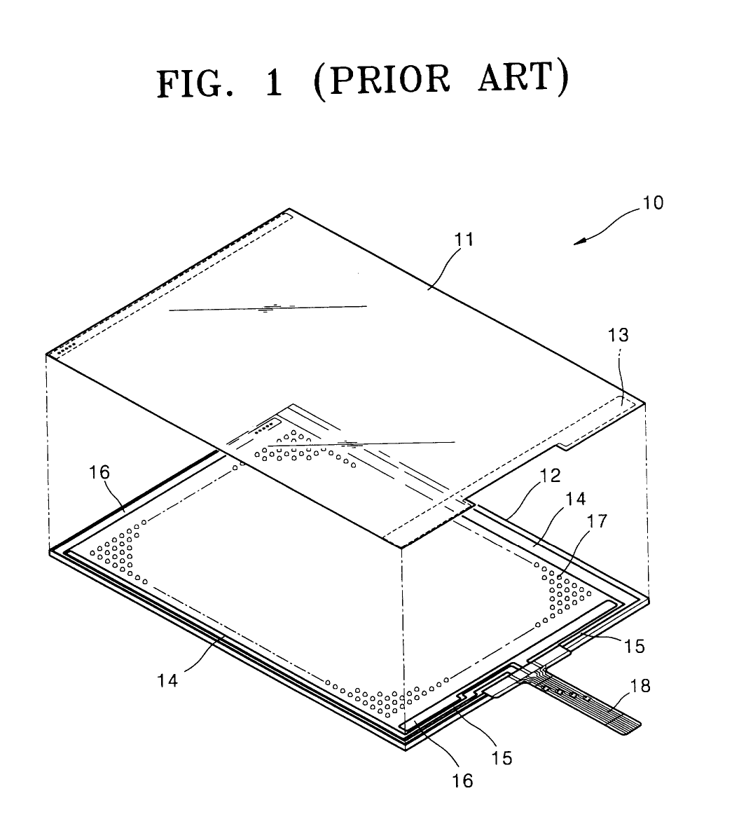

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

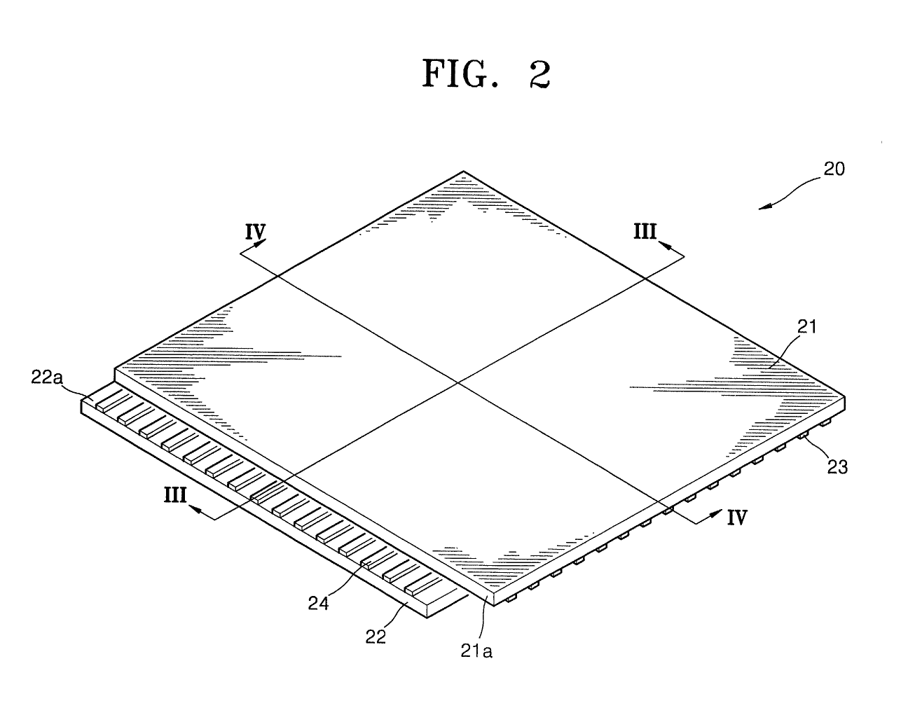

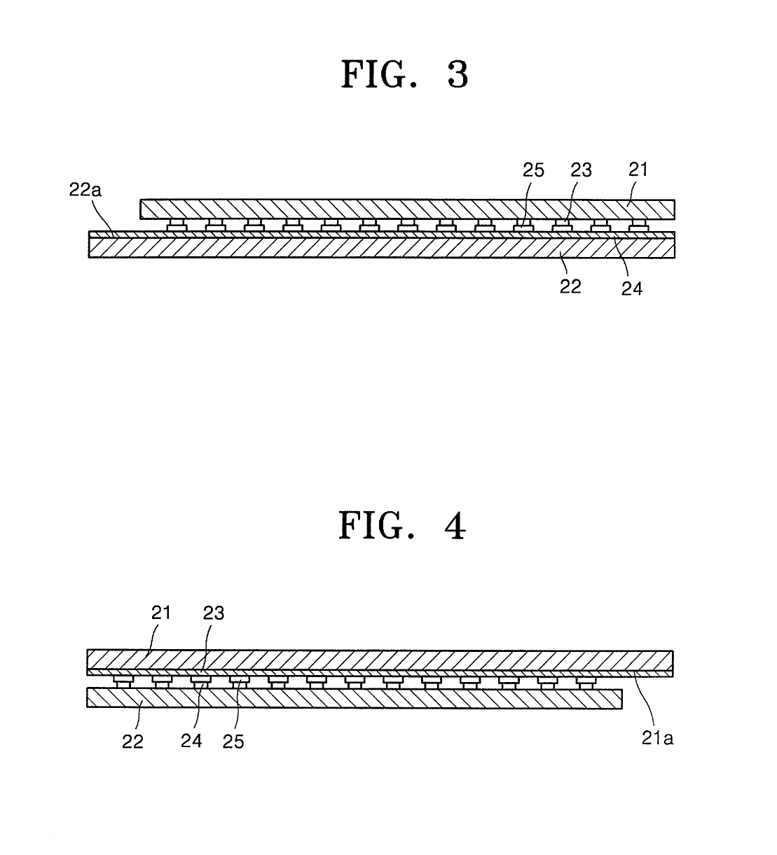

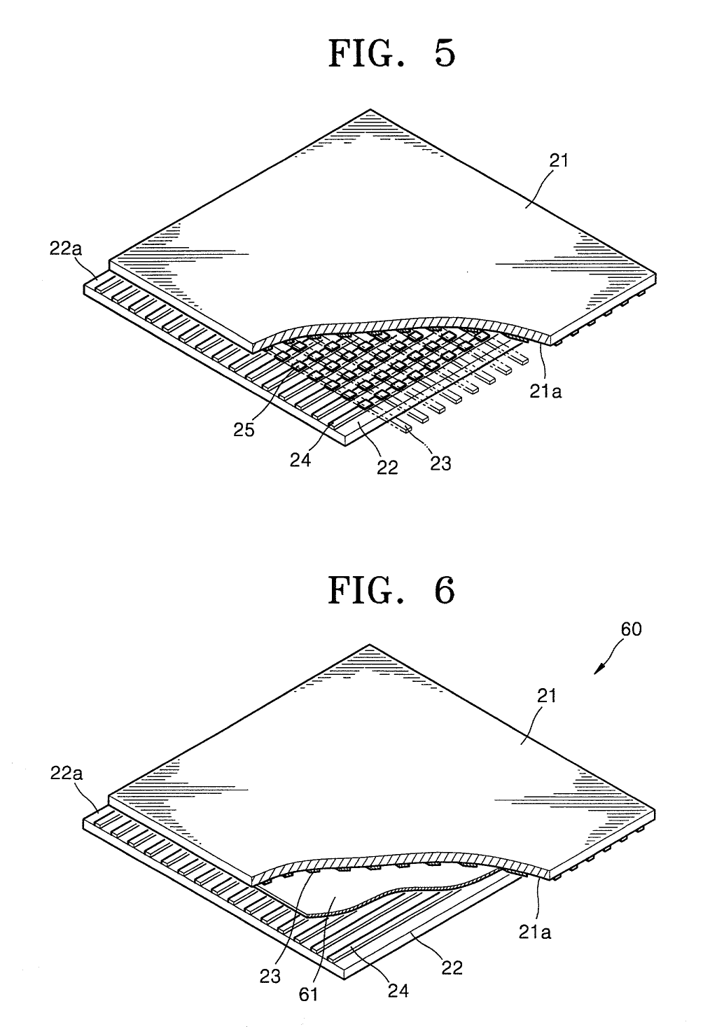

FIG. 2 illustrates a touch panel according to an embodiment of the present invention. FIGS. 3 and 4 illustrate the touch panel of FIG. 2, taken along the lines III-III and the line IV-IV, respectively. FIG. 5 illustrates the touch panel of FIG. 2 wherein a part thereof is cut away.

Referring to FIGS. 2 through 5, the touch panel 20 includes an upper substrate 21 and a lower substrate 22 disposed to face the upper substrate 21.

The upper substrate 21 can be formed of a film such as a PET film having flexibility. A plurality of upper electrodes 23 are formed in a parallel striped pattern throughout the bottom of the upper substrate 21. The lower substrate 22 can be formed of transparent glass. A plurality of lower electrodes 24 are formed in a striped pattern on the top of the lower substrate 22 so that the lower electrodes 24 and the upper electrodes 23 perpendicularly cross.

A first extended portion 21a can be formed at one side of the upper substrate 21 so that the horizontal length of the upper substrate 21 is longer than that of the lower substrate 22. In addition, a second extended portion 22a can be formed at one side of the lower substrate 22 so that the vertical length of the lower substrate 22 is longer than that of the upper substrate 21.

When the upper substrate 21 and the lower substrate 22 are coupled together, the upper electrodes 23 formed on the first extended portion 21a and the lower electrodes 24 formed on the second extended portion 22a are exposed. The exposed upper and lower electrodes 23 and 24 can be connected to external terminals (not shown). The positions of the first and second extended portions 21a and 22a are not restricted to this embodiment illustrated in FIG. 2 but instead can be changed in various shapes which can also expose the upper and lower electrodes 23 and 24.

Piezoelectric elements 25 are installed at intersections where the upper electrodes 23 meet the lower electrodes 24. In other words, the individual piezoelectric elements 25 are independently installed at every intersection where the upper electrodes 23 meet the lower electrodes 24.

Here, a piezoelectric element converts mechanical signals into electrical signals in that a piezoelectric crystal becomes electrically polarized upon application of mechanical stress.

The piezoelectric elements 25 allow the space between the upper substrate 21 and the lower substrate 22 to be appropriately maintained, so a conventional dot spacer can be omitted.

The following description concerns the operations of the touch panel 20.

If a user applies a stress to a portion of the surface of the upper substrate 21 with a predetermined device such as a pen or a finger, the stress is transmitted via an upper electrode 23 to a piezoelectric element 25. Then, the piezoelectric element 25 becomes electrically polarized. If the polarization is generated, an electromotive force is induced between the upper electrode 23 and a lower electrode 24, which together contact both sides of the piezoelectric element 25.

Accordingly, an electrical signal is generated in an external terminal electrically connected to the upper and lower electrodes 23 and 24. The electrical signal is transmitted to a circuit unit (not shown) to detect an input position, which is connected to the external terminal, so that information about an input position on the touch panel 20 can be obtained.

FIG. 6 illustrates a touch panel according to another embodiment of the present invention. In the drawings, the same reference numerals denote the same members.

As illustrated in FIG. 6, a touch panel 60 includes an upper substrate 21 and a lower substrate 22 which are disposed to face each other. A plurality of upper electrodes 23 are formed in a striped pattern on the bottom of the upper substrate 21. A plurality of lower electrodes 24 are formed in a striped pattern on the top of the lower substrate 22 so that the lower electrodes 24 and the upper electrodes 23 cross.

A first extended portion 21a is formed at one side of the upper substrate 21, and a second extended portion 22a is formed at one side of the lower substrate 22, so that the upper and lower electrodes 23 and 24 are exposed. The exposed upper and lower electrodes 23 and 24 are connected to external terminals (not shown).

A plate-shaped piezoelectric element 61 is disposed between the upper electrodes 23 and the lower electrodes 24. The plate-shaped piezoelectric element 61 is disposed in an area where the upper substrate 21 and the lower substrate 22 overlap.

If a stress is applied to a portion on the surface of the touch panel 60 with a predetermined device, an electromotive force is induced in the piezoelectric element 61. An electrical signal corresponding to the electromotive force is transmitted to a circuit unit (not shown) to detect an input position so that information about an input position can be obtained.

As described above, in a touch panel according to the present invention, a piezoelectric element is used to detect an input position, so a power supply unit conventionally used to apply a voltage to detect an input position can be omitted. Accordingly, the structure of a touch panel can be simplified.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A touch panel to detect an input position corresponding to a certain location where application of force is applied, comprising:
an upper substrate on which upper electrodes are formed;
a lower substrate on which lower electrodes are formed to intersect said upper electrodes in a cross pattern, said lower substrate being disposed to face said upper substrate; and
a piezoelectric element disposed between said upper substrate and said lower substrate to detect an input position corresponding to a certain location where force is applied.

2. The touch panel according to claim 1, wherein said piezoelectric element is disposed at each of intersections between said upper electrodes and said lower electrodes.

3. The touch panel according to claim 1, wherein said piezoelectric element has a plate shape.

4. The touch panel according to claim 3, wherein said piezoelectric element is disposed at a position where said upper substrate overlaps with said lower substrate.

5. The touch panel according to claim 1, wherein said upper electrodes and said lower electrodes are formed in a striped pattern.

6. The touch panel according to claim 1, wherein said upper and lower electrodes are transparent electrodes.

7. The touch panel according to claim 1, wherein said upper substrate comprises a first extended portion so that said upper electrodes are partially exposed, and said lower substrate comprises a second extended portion so that said lower electrodes are partially exposed.

8. The touch panel according to claim 7, wherein said first extended portion is perpendicular to said second extended portion.

9. The touch panel according to claim 1, wherein said lower substrate is formed of transparent glass.

10. The touch panel according to claim 7, wherein the exposed portion of said upper and said lower electrodes are connected to external terminals.

11. The touch panel according to claim 2, wherein said piezoelectric element comprises:
plural individual piezoelectric elements independently positioned at every intersection where said upper electrodes and said lower electrodes intersect, each said piezoelectric element converting mechanical signals into electrical signals by polarization upon application of the force to a region of the upper substrate.

12. The touch panel according to claim 11, wherein said plural individual piezoelectric elements create a space between said upper electrodes and said lower electrodes.

13. A touch panel to detect an input position corresponding to a certain location where application of force is applied, comprising:
an upper substrate;
a lower substrate, said lower substrate being disposed to face said upper substrate; and
a polarization element disposed between said upper substrate and said lower substrate to detect said input position based upon the application of force to a region of the upper substrate.
